(19) United States
(12) Patent Application Publication
(10) Pub. No.: US 2009/0110925 A1
(43) Pub. Date: Apr. 30, 2009

(54) Adhesive Composition

(75) Inventors: Katsuhito Fukuda, Hyogo (JP); Nao Naitoh, Hyogo (JP); Muneharu Hanada, Hyogo (JP); Fumio Yamane, Hyogo (JP); Motohisa Morozumi, Hyogo (JP)

Correspondence Address: WENDEROTH, LIND & PONACK, L.L.P., 1030 15th Street, N.W.,, Suite 400 East, Washington, DC, 20005-1503, US

(73) Assignee: MATSUMURA OIL RESEARCH CORP., Kobe-shi (JP)

(21) Appl. No.: 11/989,426

(22) PCT Filed: Sep. 8, 2005
(86) PCT No.: PCT/JP2005/016991

§ 371 Date: Jan. 25, 2008

(30) Foreign Application Priority Data
Jul. 29, 2005 (JP) 2005-220211

(51) Int. Cl. B32B 27/32; C09J 123/00

(52) U.S. Cl. 428/355 EN; 524/528; 428/523

(57) ABSTRACT

A hot melt adhesive composition comprising (A) 60 to 98 wt. % of a propylene-ethylene copolymer, (B) 2 to 40 wt. % of a maleic anhydride-modified polypropylene wax having a softening point of 120 to 170° C. and serving as a tackifier, and when required, (C) an antioxidant in an amount of 0.1 to 5.0 wt. % based on the combined amount of (A) and (B).

### TECHNICAL FIELD

The present invention relates to hot melt adhesive compositions, and more particularly to hot melt adhesive compositions for adhering paper, synthetic paper, plastic film, wood and the like.

### BACKGROUND ART

It is already known to use a hot melt adhesive composition for adhering different two surfaces of different materials or the same material, such as paper and wood, or paper and paper. Hot melt adhesive compositions are used by coating a substrate with the composition as melted at a high temperature by an applicator, affixing the coated substrate to an adherend before the coating solidifies and cooling the resulting assembly to room temperature, whereby the composition exhibits adhesion.

When one kind of convention adhesive compositions is used for adhering same substrates to adherends under certain conditions, the composition used exhibits the same adhesion strength. The conditions include the coating temperature or environmental temperature, the time taken for affixing the substrate to the adherend, the amount of the adhesive composition, etc. Although the adhesion strength varies slightly when the coating conditions differ, it is impossible to greatly vary the adhesion strength intentionally or as desired. The adhesion strength can not be adjusted to a small value for the purpose of peeling or to a great value so as not to permit peeling, for example, merely by altering the coating conditions.

Accordingly, a single adhesion strength is required of a single adhesive composition. The adhesive composition is changed for giving an altered adhesion strength. When a single adherend is to be affixed to a material with at least two different adhesion strengths, a least two kinds of adhesive compositions are used. This entails the problem of necessitating a cumbersome process or process management.

When a sheet is to be affixed to an information recording surface as in making information recording media necessitating pseudoadhesion, such as confidential postcards or opening preventing labels, it is difficult to use a usual hot melt for affixing the sheet with an adhesion strength providing pseudoadhesion. The sheet will remain unadhered locally, with another portion thereof adhered with such a high strength as to cause a break, and can not be adhered with a contemplated strength. Further, in order to prevent faulty peeling of the sheet owing to a change in the surface tack of the adhesive composition with the lapse of time, it has been necessary to coat not only the composition but also the surface to be adhered with silicone or wax for the adjustment of the adhesion strength (see, for example, Patent Literature 1 and 2).

The term “pseudoadhesion” refers to the state of two layers which are adhered in the usual state but which can be readily peeled off from each other merely manually without using any tool or the like, such that the separated two layers can not be adhered together again when merely fitted to and pressed against each other. Pseudoadhesion differs from lamination with a common tackifying agent in that “the two layers can not be adhered together again when merely fitted to and pressed against each other.”

Incidentally, usual hot melt adhesive compositions are already known which comprise a base polymer [amorphous polyolefin (generally termed APAO), EVA, synthetic rubber, polyamide, polyester or the like], and a tackifier, softening agent, antioxidant, etc. which are kneaded with heating (see, for example, Patent Literature 3 and 4).

Although the hot melt adhesive composition described is usable in a field wherein usual hot melt adhesives are used, for example, for affixing paper, synthetic paper, plastic film and the like, the composition is not suited for affixing a sheet to information bearing surfaces in making information recording media necessitating pseudoadhesion, such as confidential postcards and opening preventing labels.

[Patent Literature 1] JP 1992-156394A

[Patent Literature 2] JP 3078054Y1

[Patent Literature 3] JP 2001-19926A

[Patent Literature 4] JP 2003-220311A

An object of the present invention is to provide a hot melt adhesive composition (1) which is usable as a general-purpose hot melt adhesive, (2) which can be fitted to an adherend after coating, cooling to room temperature and reheating, or can be heated as fitted to an adherend, so as to exhibit desired adhesion strengths involving nontacky, pseudoadhesion and strong adhesion, and (3) which also has the function of affixing a sheet by pseudoadhesion while permitting the sheet to be peeled off so that the sheet can be affixed again after peeling when heated at a temperature effecting pseudoadhesion, the composition thus being made usable repeatedly.

### DISCLOSURE OF THE INVENTION

The present invention has the following features.

1. A hot melt adhesive composition comprising (A) 60 to 98 wt. % of a propylene-ethylene copolymer and (B) 2 to 40 wt. % of a maleic anhydride-modified polypropylene wax having a softening point of 120 to 170° C. and serving as a tackifier.

2. A hot melt adhesive composition comprising (A) 60 to 98 wt. % of a propylene-ethylene copolymer, (B) 2 to 40 wt. % of a maleic anhydride-modified polypropylene wax having a softening point of 120 to 170° C. and serving as a tackifier and (C) an antioxidant in an amount of 0.1 to 5.0 wt. % based on the combined amount of (A) and (B).

3. A hot melt adhesive composition according to par. 1 or 2 for producing postcards and labels in making personal letters or information media for the protection of information.

4. An information medium produced by using a hot melt adhesive composition according to any one of the above pars. in adhering paper, synthetic paper, plastic film or like adherend for the purpose of protecting information.

5. An information medium produced by using a hot melt adhesive composition according to any one of the above pars. in adhering paper, synthetic paper, plastic film or like adherend for the purpose of pseudoadhesion.

The present invention provides a hot melt adhesive composition, which is used by coating a substrate therewith, cooling the coating to room temperature, thereafter heating the coating as placed over an adherend. This enables the composition to exhibit a desired adhesion strength such as nontacky, pseudoadhesion and strong adhesion, depending on the heating temperature. The hot melt adhesive composition is suited especially for affixing paper, plastic film, wood, etc.

Stated more specifically, the hot melt adhesive composition of the invention is first applied to a substrate in a molten state using, for example, a slot coater. The coating is then cooled to room temperature without placing any material thereover. This nullifies the tack of the coating surface. When the adhesive composition as solidified is thereafter heated to a predetermined temperature, only a portion of the adhesive component (crystal portion of the material) melts to exhibit a tack. If the coating is thereafter affixed to an adherend and when the assembly is cooled again to room temperature, the hot melt adhesive used has the function of effecting adhesion with a desired strength in accordance with the heating temperature.

This function is available when a hot melt is used which comprises a polypropylene-ethylene copolymer (hereinafter referred to as “PP/E resin”) as its base polymer. The hot melt can be made into a contemplated hot melt adhesive composition when further comprising, in addition to the PP/E resin, a tackifier for giving tack and another component such as an antioxidant for giving heat resistance and oxidation resistance to the holt melt.

According to the present invention, the PP/E resin (A) is a copolymer of propylene and ethylene. Examples of copolymers usable are a random copolymer, block copolymer and graft copolymer of propylene and ethylene. The random copolymer of propylene and ethylene is especially preferable.

Although the PP/E resin to be used is not limited particularly insofar as the resin exhibits the desired properties contemplated by the invention, ethylene is desirable which is 7 to 16 mole %, more preferably 10 to 14 mole %, in polypropylene content. Furthermore, random copolymers are more preferred than block copolymers and graft copolymers. The more randomly ethylene is dispersed in propylene, the smaller the propylene crystals become, with the result that the copolymer has flexibility at room temperature, is meltable at a lower temperature with a smaller amount of heat and exhibits the desired properties of the invention with greater ease.

The adhesive composition of the invention contains preferably 60 to 98 wt. %, more preferably 70 to 95 wt. %, of the PP/E resin (A).

The percentage of ethylene in propylene can be quantitatively determined by ¹³C-NMR. If the proportion of ethylene is too small, larger polypropylene crystals are present in an increased amount to result in lower flexibility and necessitate a larger quantity of heat for melting. Since it is likely that the adhesive composition will be applied to uses involving reseparation or pseudoadhesion, or that the product obtained by adhesion must be flexible, hard (less flexible) adhesive compositions are not suitable. If hard, the adhesive composition fails to become mitigated in deformation stress when the adherend is peeled off or separated again or bent, giving rise to a rupture in the adhesive layer or a local break in the material of the adherend or substrate. Conversely, the presence of an excess of ethylene excessively reduces the amount of polypropylene crystals to result in lower cohesion and increased tack.

For the composition to have no tack and retain flexibility, it is most desirable to copolymerize a small amount of ethylene with the main chain of polypropylene at a uniform spacing. Uneven distribution of ethylene in the polypropylene bond decreases the effect to limit the growth of polypropylene crystals. The uneven distribution of ethylene in the polypropylene bond can be evaluated by determining the percentage of ethylene by 13C-NMR to quantitatively determine the E-E bond ratio therein. The term “E-E bond ratio” represents the uneven distribution of ethylene in propylene. In the PP/E resin, the propylene-to-propylene bond will be referred to as “P-P bond,” the propylene-to-ethylene bond as “P-E bond,” and the ethylene-to-ethylene bond as “E-E bond.” Random polymerization is low in E-E bond ratio since ethylene is present in polypropylene without nonuniform distribution. Conversely the nonuniform distribution of ethylene in polypropylene as in block copolymers or graft copolymers entails a greater E-E bond ratio. The E-E bond ratio in the ethylene in the PP/E resin exhibiting the desired properties of the invention is preferably up to 10%, more preferably 1 to 8%.

Furthermore, the PP/E resin is 75 to 100° C., more preferably 80 to 92° C., in transition temperature. The heat of transition of the PP/E resin is preferably 25 to 40 J/g, more preferably 28 to 37 j/g. The term “transition temperature” as used herein refers to the transition peak temperature as measured using DSC by the method provided in JIS K 7120. The heat of transition is determined from the area surrounded by the base line and the transition peak temperature as measured using DSC by a method similar to the method provided in JIS K 7120.

The melt viscosity of the PP/E resin is preferably 500 to 50000 mPa·s, most preferably 1000 to 20000 mPa·s, at 170° C. If the resin has too low a melt viscosity and when the composition is applied to paper or wood, the resin will penetrate into the substrate before solidifying. When the substrate is paper, the resin will ooze out through the rear surface thereof like an oily stain to result in an impaired appearance, hence an objectionable result (oil bleeding). In the case where the substrate is porous like wood, the adhesive composition on the adherend surface will flow into the wood to entail faulty adhesion. If the resin is excessively high in melt viscosity, seriously impaired coatability will result to impose limitations on the coating method. When a slot coater or roll coater, which is in common use for coating paper, is used, the melt viscosity is up to 50000 mPa·s, preferably up to 20000 mPa·s. In the case where gravure coating or silicone rubber transfer coating is to be performed, the melt viscosity is preferably up to 10000 mPa·s. Such a PP/E resin is commercially made available by Clariant under the trade name of Licocene.

With the adhesive composition of the present invention, therefore, the PP/E resin is preferably a random copolymer of propylene and ethylene which is 7 to 16 mole % in ethylene content, 25 to 40 J/g in heat of transition, 75 to 100° C. in transition temperature and 500 to 50000 mPa·s in melt viscosity at 170° C.

The object of the invention can be fulfilled easily when the maleic anhydride-modified polypropylene wax is used as a tackifier because the wax has the function of reducing the influence on the transition temperature, transition heat and flexibility of the PP/E resin, giving adhesivity by virtue of the polarity thereof and shortening the open time (ensuring improved productivity), by virtue of its crystallinity. Further if the tackifier used has a softening point of 120 to 170° C., there is no likelihood of exhibiting tack in the environment of room temperature during any season. The tackifier further does not impair the flexibility and is therefore desirable. The hot melt adhesive composition of the invention contains preferably 2 to 40 wt. %, more preferably 5 to 30 wt. %, of the tackifier.

Further when required, it is possible to use in combination with the above tackifier another known tackifier such as aromatic petroleum resin, aliphatic petroleum resin, aliphatic-aromatic petroleum resin, terpene resin, rosin resin, modified terpene resin, modified rosin resin or styrene petroleum resin, in an amount that will not be objectionable to the purpose, for example, preferably in an amount of up to 20 wt. %, more preferably in an amount of 1 to 15 wt. %, based on the maleic anhydride-modified polypropylene wax.

The maleic anhydride-modified polypropylene wax having a softening point of 120 to 170° C. is an adduct of waxlike crystalline polypropylene having a softening point of 120 to 170° C. with maleic anhydride. Known maleic anhydride-modified polypropylene waxes are usable, and those commercially available can be used. Such tackifiers commercially available are, for example, Yumex, product of Sanyo Chemical Industries, Ltd., Licomont, product of Clariant and A-C, product of Honeywell.

The antioxidant to be used in the invention can be any of those usually used. Examples of preferred antioxidants are phenolic antioxidants, phosphoric antioxidants and sulfuric antioxidants. These antioxidants can be used singly or in admixture. The hot melt adhesive composition of the present invention contains preferably 0.1 to 5 parts by weight, more preferably 0.3 to 3 parts by weight, of the antioxidant per 100 parts by weight of the composition.

In addition to the antioxidant, various additives usually used for hot melt adhesives can be incorporated into the hot melt adhesive composition of the present invention. Such additives serve to generally improve the characteristics of the hot melt adhesive composition and to permit postcards or like information media to retain their quality. Examples of additives usable are stabilizers (antioxidants or the like) for giving improved weather resistance, ultraviolet absorbers for preventing ultraviolet deterioration, flame retardants, hot melt adhesive antiblocking agents, inorganic fillers for inhibiting contraction, etc.

The hot melt adhesive composition described of the present invention is usable in a field wherein usual hot melt adhesives are used, for example, for affixing paper, synthetic paper, plastic film and the like. The composition is suited especially for affixing a sheet to information bearing surfaces in making information recording media necessitating pseudoadhesion, such as confidential postcards, opening preventing labels and delivery slip labels.

When a heat roll worked in relief is used for heating a composition bearing substrate as superposed on an adherend, only the desired portion of the substrate can be adhered. Further when the substrate is heated with several heat rolls which are different in temperature, desired portions can be affixed with at least two different adhesion strengths. This enables label manufacturers to make labels realizing a novel idea.

An adherend is placed over a substrate coated with a hot melt adhesive composition, and the assembly is heated. Depending on the heating temperature, this results in no tack, pseudoadhesion or strong adhesion as illustrated.

A sheet of high-quality paper serving as an adherend is placed over a sheet of paper coating with an adhesive composition. The assembly is then heated. Plotted as abscissa in FIG. 1 is the heating temperature, and as ordinate the peel strength measured when the sheets of paper are peeled off from each other. Plotting with marks ⋄ represents an exemplary hot melt adhesive composition of the invention, and plotting with marks Δ represents a conventional hot melt adhesive composition.

Plotting with marks Δ reveals that the usual hot melt adhesive composition has tack at temperatures of up to 45° C., starts to exhibit adhesivity at 55° C. and effects adhesion force with such a peel strength as to break the paper at 60° C. Since the composition has tack at temperatures of up to 45° C., interposed release paper is needed in taking up the coated paper into a roll. Although the composition starts to exhibit adhesion force at 55° C., the adhesion force varies widely in value, and the adherend is affixed locally and yet remains unaffixed locally, whereas the high-quality paper becomes locally broken when peeled off. This indicates that the composition is not applicable to uses involving pseudoadhesion. When the paper serving as an adherend is superposed on paper coated with the usual adhesive composition and then heated like the product of the invention, the paper can be adhered only with such a strength as to cause a break in the paper.

In contrast, the composition of the invention remains completely nontacky at temperatures of up to 65° C., starts to exhibit adhesivity at 70° C. and effects adhesion force at 105° C. with such a peel strength as to break the paper. Since the composition remains nontacky at temperatures of up to 65° C., there is no need to use release paper or the like when the coated paper is to be taken up into a roll. When the composition is heated at 75 to 90° C., the adhesion strength can be controlled by adjusting the temperature, and the adherend can be affixed by pseudoadhesion with diminished variations in adhesion strength. Such function indicates that the composition exhibits a desired adhesion strength such as nontacky, pseudoadhesion or strong adhesion.

### BRIEF DESCRIPTION OF THE DRAWINGS

FIG. 1 is a graph showing the relationship between the reheating temperature and the peel strength as determined for hot melt adhesive compositions; and

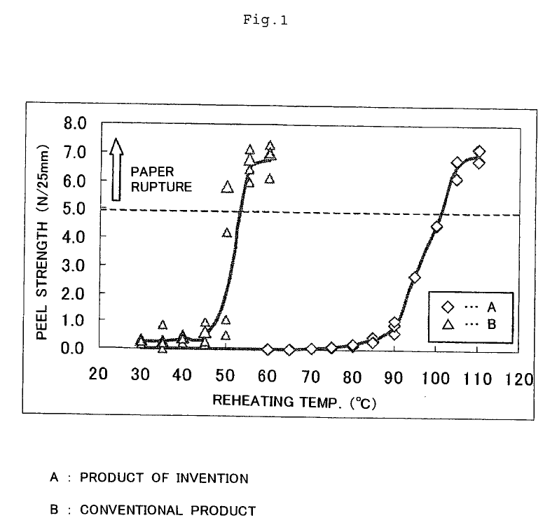

FIG. 2 is a diagram showing nontacky, pseudoadhesion and strong adhesion effected by heating the coating of a hot melt adhesive composition of the invention.

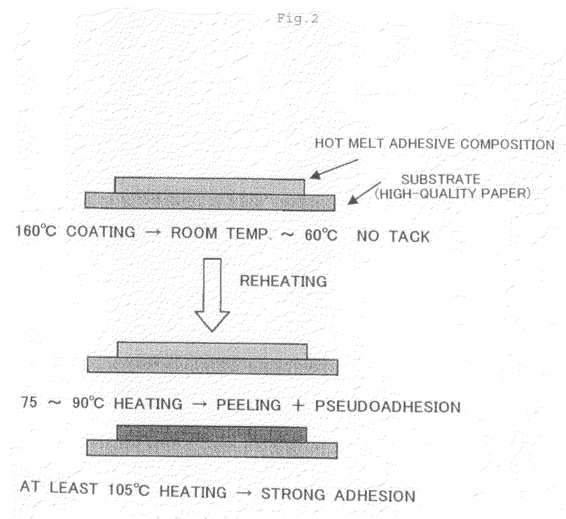

### BEST MODE OF CARRYING OUT THE INVENTION

The present invention will be described below in detail with reference to Examples and Comparative Examples. However, the invention is not limited in any way by these examples.

Components (A) and (B) will be described below which were used for preparing hot melt adhesive compositions of Examples and Comparative Examples.

(A1) is a PP/E resin [Licocene PP-1502 (trade name), product of Clariant] which is a random copolymer of propylene and ethylene and which is 28 J/g in heat of transition, 80° C. in transition temperature, 1800 mPa·s in melt viscosity at 170° C., 13% in ethylene content and 4% in E-E bond ratio thereof.
(A2) is a PP/E resin [Licocene PP-2602 (trade name), product of Clariant] which is a random copolymer of propylene and ethylene and which is 37 J/g in heat of transition, 91° C. in transition temperature, 6000 mPa·s in melt viscosity at 170° C., 10% in ethylene content and 3% in E-E bond ratio thereof.
(A3) is a copolymer (APAO) of amorphous propylene and ethylene [Rextac RT-2535 (trade name), product of Huntsman] which is 7 J/g in heat of transition, 130° C. in transition temperature, 7000 mPa·s in melt viscosity at 170° C., 15% in ethylene content and 26% in E-E bond ratio thereof.
(A4) is a PP/E resin [Licocene PP-4202 (trade name), product of Clariant] which is a random copolymer of propylene and ethylene and which is 23 J/g in heat of transition, 111° C. in transition temperature, 70 mPa·s in melt viscosity at 170° C., 5% in ethylene content and 1% in E-E bond ratio thereof.
(B1) is a crystalline polypropylene wax [Yumex Y-1001 (trade name), product of Sanyo Chemical Industries, Ltd.] which has its terminal end modified with maleic anhydride and 154° C. in softening point.
(B2) is a crystalline polypropylene wax [Licomont AR504 (trade name), product of Clariant] which is graft-modified with maleic anhydride and has a softening point of 156° C.
(B3) is a C9 completely hydrogenated petroleum resin [Arkon P-140 (trade name), product of Arakawa Kagaku Kogyo Co., Ltd.] which is 140° C. in softening point.
(B4) is a C9 completely hydrogenated petroleum resin [Arkon P-90 (trade name), product of Arakawa Kagaku Kogyo Co., Ltd.] which is 90° C. in softening point.

The physical properties of (A) and (B) were determined by the following methods.

### Transition Temperature and Heat of Transition

The transition peak temperature measured with DSC using the method provided in JIS K 7120 and the peak area were read. For temperature measuring with DSC, a 15 mg quantity of sample was heated once to 200° C. at a rate of 20° C./min and thereafter cooled to −100° C. at a rate of 10° C./min to give the sample a definite heat history. The sample was thereafter heated at a rate of 10° C./min to measure the transition temperature and the heat of transition. The device used was DSC 3100SR, product of Bruker axs.

The ethylene content (%) was calculated from the chemical shift area ratio detected using ¹³C-NMR. Used for the measurement was a sample as diluted to a concentration of 30% with o-dichlorobenzene solvent as heated at 135° C., and integration was made 3500 times. According to the method described in New Edition Handbook of High Polymer Analysis, published by Kinokuniya Shoten (edited by the Japan Society for Analytical Chemistry), the ethylene content (%) was calculated from the equation [0.5×(S_{βδ}+S_{δδ}+S_{αγ}+S_{αδ})+0.25×S_{γδ}]/(0.5×S_{βδ}+0.5×S_{δδ}+S_{αγ}+S_{αδ}+0.25+S_{γδ}+0.25×S_{αα})×100 wherein S_{αα} is the peak area at 47.0-45.8 ppm, S_{αγ} is the peak area at 38.0 ppm, S_{αδ} is the peak area at 37.5 ppm, S_{γδ} is the peak area at 30.4 ppm and S_{δδ} is the peak area at 30.0 ppm. E-E % can be calculated by dividing the area S_{δδ} by the area of ethylene %. The device used was JNM-ECX400, product of Nippon Denshi Co., Ltd.

The melt viscosity was measured at the indicated temperature by the method provided in JIS K 6862 using a Brookfield viscometer (H3 rotor).

The softening point was measured by a method similar to the method provided in JIS K 2207, i.e., R and B method (ring and ball method).

### EXAMPLE 1

### Preparation of Hot Melt Adhesive Composition

Into a container were placed 90 wt. % of Licocene PP-1502 (A1) and 10 wt. % of Yumex Y-1001 (B1), which were then uniformly mixed together for melting while heating the components at 170° C. for 1 hour. To 100 parts by weight of the resulting composition was added 0.5 part by weight of a phenolic antioxidant (Sumilizer BP101, product of Sumitomo Chemical Co., Ltd.) (C) to obtain a hot melt adhesive composition.

### EXAMPLES 2 AND 3

Hot melt adhesive coating compositions were prepared in Examples 2 and 3 in the same manner as in Example 1 with the exception of using the components listed in Table 1 in the amounts listed in place of those used in Example 1. The same methods as described in Example 1 were used for the evaluation of the hot melt adhesive compositions of Examples 2 and 3. Table 1 shows the results.

### COMPARATIVE EXAMPLES 1 TO 6

Hot melt adhesive coating compositions were prepared in Comparative Examples 1 to 6 in the same manner as in Example 1 with the exception of using the components listed in Table 1 in the amounts listed in place of those used in Example 1. The same methods as described in Example 1 were used for the evaluation of the hot melt adhesive compositions of Comparative Examples 1 to 6. Table 1 shows the results.

The hot melt adhesive compositions were evaluated using the following methods.

Tack: A sheet of high-quality paper in the form of a roll was coated with the hot melt adhesive composition to a thickness of 30 μm using a slot coater. Another sheet of high-quality paper was superposed on the coating, a weight was placed on the resulting assembly so to give a pressure of 80 g/cm², and the assembly was thereafter allowed to stand in a constant-temperature chamber of 40° C. for 24 hours and subsequently cooled to room temperature. The superposed sheet of paper was peeled off at a rate of 300 mm/min at 20° C. to measure the peel strength for evaluation. The peel strength is indicated by ⊚ when less than 0.2 N/25 mm, or by X when at least 0.2 N/25 mm. Alternatively, if the high-quality paper broke at least locally during peeling, the result is indicated by X.
Adhesion force: A sheet of high-quality paper in the form of a roll was coated with the hot melt adhesive composition to a thickness of 30 μm using a slot coater. Another sheet of high-quality paper was superposed on the coating, and the two sheets of paper and the coating were heated at a temperature of not lower than the softening point of the base polymer for 3 seconds using a heat roller. The assembly was thereafter cooled to room temperature, and the superposed sheet of paper was peeled off at a rate of 300 mm/min at 20° C. to measure the peel strength for evaluation. The peel strength is indicated by ⊚ when at least 5 N/25 mm, permitting a break in the high-quality paper, or by Δ when less than 5 N/25 mm to at least 2 N/25 mm, indicating only low adhesion force, When the peel strength was less than 2 N/25 mm, permitting the high-quality paper to remain unbroken and leaving the paper unadhered at least locally to show great variations in the degree of adhesion force, the result is indicated by X.
Pseudoadhesion: A sheet of high-quality paper in the form of a roll was coated with the hot melt adhesive composition to a thickness of 30 μm using a slot coater. Another sheet of high-quality paper was superposed on the coating, and the two sheets of paper and the coating were heated between 40° C. to 100° C. with stepwise increases of 5° C. for 3 seconds using a heat roller. The assembly was thereafter cooled to room temperature, and the superposed sheet of paper was peeled off at a rate of 300 mm/min at 20° C. to measure the peel strength for evaluation. The peel strength is indicated by ⊚ when in the range of 1 N/25 mm to 5 N/25 mm, permitting the separation of the sheets without causing a break in the high-quality paper, or by O when up to 1 N/25 mm or at least 5 N/25 mm, permitting the peeled-off sheet of high-quality paper to remain unbroken. When the peel strength remained unstable, permitting the high-quality paper to break locally and to remain unadhered locally at the same time to show great variations in the degree of tack, the result is indicated by X.
Flexibility: A sheet of high-quality paper in the form of a roll was coated with the hot melt adhesive composition to a thickness of 30 μm using a slot coater. The paper coated with the composition was wound up on a paper tube having a diameter of 10 mm and thereafter unwound to extend straight, and the coating was checked for cracks. If the coating had no cracks, the result is indicated by ⊚, while if the coating developed cracks or became peeled off from the paper, the result is indicated by X.
Coatability: The hot melt adhesive composition was checked as to whether it is applicable by a common hot melt applying device (applicator, slot coater). When the composition was applicable at a temperature of up to 200° C. to an actual thickness with an error of up to 30% based on the set value of thickness, the result is indicated by ⊚, while if the error of the actual thickness was at least 100% relative to the set value of thickness, for example, owing to a high melt viscosity, the result is indicated by X.
Bleeding resistance on paper: A sheet of high-quality paper in the form of a roll was coated with the hot melt adhesive composition to a thickness of 30 μm using a slot coater. Another sheet of high-quality paper was superposed on the coating, a weight was placed on the resulting assembly so to give a pressure of 80 g/cm², and the assembly was thereafter allowed to stand in a constant-temperature chamber of 80° C. for 168 hours and subsequently cooled to room temperature. If the low-molecular-weight component or the like of the composition did not ooze out through the surface of the high-quality paper like an oily stain, the result is indicated by ⊚, while if an oily stain was visually recognizable, the result is indicated by X.
Change over time: A sheet of high-quality paper in the form of a roll was coated with the hot melt adhesive composition to a thickness of 30 μm using a slot coater. After the composition coating cooled to room temperature, the coated paper was wound into a roll without using any interposed release paper. The roll was then subjected to a heat cycle of −20° C. and +50° C., and this cycle was repeated ten times over a period of 10 days. The roll was thereafter returned to room temperature and checked for evaluation. If the rear surface of the substrate (high-quality paper) remained unadhered to the composition coating, the result is indicated by ⊚. When the high-quality paper was found slightly adhered to the coating but was not found broken or fluffy, the result is indicated by O. If the rear surface of the substrate (high-quality paper) remained adhered to the composition coating and unseparable therefrom, the result is indicated by X. Table 1 shows the results.

TABLE 1

| | Example | | | Comparative Example | | | | | |
|---|---|---|---|---|---|---|---|---|---|
| | 1 | 2 | 3 | 1 | 2 | 3 | 4 | 5 | 6 |
| (A1) | 90 | 65 | | 100 | 50 | | | 90 | 90 |
| (A2) | | | 90 | | | | | | |
| (A3) | | | | | | 90 | | | |
| (A4) | | | | | | | 90 | | |
| (B1) | 10 | 35 | | | 50 | 10 | 10 | | |
| (B2) | | | 10 | | | | | | |
| (B3) | | | | | | | | 10 | |
| (B4) | | | | | | | | | 10 |
| (C) | 0.5 | 0 | 0.5 | 0.5 | 0.5 | 0.5 | 0.5 | 0.5 | 0.5 |
| Low- | ⊚ | ⊚ | ⊚ | ⊚ | X | X | ⊚ | ⊚ | X |
| temp. tack | | | | | | | | | |
| Adhesion | ⊚ | ⊚ | ⊚ | X | ⊚ | ⊚ | ⊚ | ⊚ | ⊚ |
| Pseudo- | ⊚ | ⊚ | ⊚ | X | ⊚ | X | X | ⊚ | X |
| adhesion | | | | | | | | | |
| Flexibility | ⊚ | ⊚ | ⊚ | ⊚ | X | ⊚ | X | X | X |
| Coat- | ⊚ | ⊚ | ⊚ | ⊚ | ⊚ | ⊚ | ⊚ | ⊚ | ⊚ |
| ability | | | | | | | | | |
| Bleeding | ⊚ | ⊚ | ⊚ | ⊚ | X | ⊚ | X | ⊚ | ⊚ |
| resistance | | | | | | | | | |
| Change | ⊚ | ⊚ | ⊚ | ⊚ | X | X | X | X | X |
| with time | | | | | | | | | |

The amounts of components are in wt. % based on the combined amount of the components (A) and (B).

### INDUSTRIAL APPLICABILITY

The present invention provides a hot melt adhesive composition which is usable as a general-purpose hot melt adhesive, and which can be fitted to an adherend after coating, cooling to room temperature and reheating, or can be heated as fitted to an adherend, so as to exhibit desired adhesion strengths involving nontacky, pseudoadhesion and strong adhesion. The composition also has the function of affixing a sheet by pseudoadhesion while permitting the sheet to be peeled off so that the sheet can be affixed again after peeling when heated at a temperature effecting pseudoadhesion, the composition thus being made usable repeatedly.

Furthermore, the hot melt adhesive composition of the invention becomes nontacky when applied to paper or like substrate and then cooled to room temperate. The coated substrate can therefore be taken up into a roll as it is without necessitating release paper, release coat or like protecting means for the coating surface. Because the conventional hot melt adhesive composition fails to become completely nontacky and further because paper coated with the conventional composition and taken up into a roll is likely to become tacky owing to the winding pressure, release paper or the like is interposed between the adhesive coating surface and the rear surface of the substrate. The release paper or release coat is costly, while the paper is not reusable as recycled paper, so that the present composition, which dose not require the use of release paper, has the advantage of achieving a cost reduction and also being environmentally friendly.

1-8. (canceled)

9. A hot melt adhesive composition comprising (A) 60 to 98 wt. % of a propylene-ethylene copolymer which is 0 to 10 in E-E bond ratio in the ethylene and 7 to 16 mole % in ethylene content and (B) 2 to 40 wt. % of a maleic anhydride-modified polypropylene wax having a softening point of 120 to 170° C. and serving as a tackifier.

10. A hot melt adhesive composition comprising (A) 60 to 98 wt. % of a propylene-ethylene copolymer, (B) 2 to 40 wt. % of a maleic anhydride-modified polypropylene wax having a softening point of 120 to 170° C. and serving as a tackifier and (C) an antioxidant in an amount of 0.1 to 5.0 wt. % based on the combined amount of (A) and (B).

11. A hot melt adhesive composition according to claim 9 or 10 wherein the propylene-ethylene copolymer (A) is a random copolymer of propylene and ethylene.

12. A hot melt adhesive composition according to claim 9 or 10 wherein the propylene-ethylene copolymer (A) is 25 to 40 J/g in heat of transition, 75 to 100° C. in transition temperature and 500 to 50000 mPa·s in melt viscosity at 170° C.

13. A hot melt adhesive composition according to claim 9 or 10 wherein the tackifier (B) comprises a crystalline polypropylene wax modified with maleic anhydride.

14. A hot melt adhesive composition according to claim 9 or 10 for producing postcards and labels in making personal letters or information media for the protection of information.

15. An information medium produced by using a hot melt adhesive composition according to claim 9 or 10 in adhering an adherend for the purpose of protecting information.

16. An information medium produced by using a hot melt adhesive composition according to claim 9 or 10 in adhering an adherend for the purpose of pseudoadhesion.
